(19) United States
(12) Patent Application Publication
(10) Pub. No.: US 2015/0122176 A1
(43) Pub. Date: May 7, 2015

(54) DISPENSING APPARATUS

(71) Applicants: PROTEK (SHANGHAI) LIMITED, Shanghai (CN); PEGATRON CORPORATION, Taipei City (TW)

(72) Inventors: Tsung-Huang MA, Taipei City (TW); Xiu-Xia FAN, Shanghai (CN)

(21) Appl. No.: 14/527,126

(22) Filed: Oct. 29, 2014

Related U.S. Application Data
(60) Provisional application No. 61/898,848, filed on Nov. 1, 2013.

(51) Int. Cl. B05C 11/10; B05C 9/02

(52) U.S. Cl. CPC B05C 11/10; B05C 9/02; Y10S 901/43
USPC 118/712; 901/43

(57) ABSTRACT

A dispensing apparatus used to dispense glue on a workpiece includes a first conveyer, a robot arm and a first storing module. The first conveyer has a work region and a storage region. The workpiece is loaded on the first conveyer and transmitted from the work region to the storage region. The robot arm is movably disposed adjacent to the work region and has a dispensing unit and an image identifying unit. The image identifying unit retrieves an image signal of the work region. The robot aim controls the dispensing unit to dispense glue on the workpiece according to the image signal of the work region. The first conveyer transmits the dispensed workpiece from the work region to the storage region. The first storing module, which is disposed adjacent to the storage region, supports the dispensed workpiece and lifts it away from the first conveyer.

### CROSS REFERENCE TO RELATED APPLICATIONS

The non-provisional patent application claims priority to U.S. provisional patent application with Ser. No. 61/898,848 filed on Nov. 1, 2013. This and all other extrinsic materials discussed herein are incorporated by reference in their entirety.

### BACKGROUND

1. Technology Field

The disclosure relates to a dispensing apparatus.

2. Related Art

As the development of mechanical technology, the automatic machines have been introduced into the production line for sufficiently reducing the cost of operators. In addition, the automatic machines can also greatly improve the production rate. In general, the automatic machine executes a preset action to a workpiece located at a preset position during a preset period. Unfortunately, the automatic machine cannot be immediately adjusted according to the actual position of the workpiece, so the production will exist a certain tolerance.

### SUMMARY

The present invention discloses a dispensing apparatus used to dispense glue on a workpiece. The dispensing apparatus includes a first conveyer, a robot arm and a first storing module. The first conveyer has a work region and a storage region. The workpiece is loaded on the first conveyer and transmitted from the work region to the storage region. The robot arm is movably disposed adjacent to the work region. The robot arm has a dispensing unit and an image identifying unit. The image identifying unit retrieves an image signal of the work region. The robot arm controls the dispensing unit to dispense glue on the workpiece according to the image signal of the work region. The first conveyer transmits the dispensed workpiece from the work region to the storage region. The first storing module is disposed adjacent to the storage region. The first storing module supports the dispensed workpiece and lifts it away from the first conveyer.

In one embodiment, the first storing module includes two storing units disposed facing to each other, and each storing unit has a plurality of supporting portions for supporting and lifting the dispensed workpiece.

In one embodiment, the dispensing apparatus further includes an accommodating box disposed adjacent to the work region.

In one embodiment, the robot arm further has a suction unit. The image identifying unit retrieves the image signal of the dispensed workpiece, and the robot arm controls the suction unit to suck the dispensed workpiece according to the image signal of the dispensed workpiece and places the dispensed workpiece in the accommodating box.

In one embodiment, the image identifying unit is a CCD sensor or a CMOS sensor.

In one embodiment, the workpiece includes a display panel, a touch panel or a casing of an electronic device.

In one embodiment, the dispensing apparatus further includes a second conveyer and a second storing module. The second conveyer is disposed at one side of the robot arm, while the first conveyer and the second conveyer are located at opposite sides of the robot arm. Another workpiece is loaded on the second conveyer. The second storing module is disposed at one side of the robot arm, while the first storing module and the second storing module are located at opposite sides of the robot arm.

In one embodiment, a horizontal projection area of the dispensing apparatus is 1 m².

As mentioned above, the dispensing apparatus of the invention is configured with an image identifying unit disposed on the robot arm, so it can precisely dispense glue on the workpiece so as to reduce the tolerance.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a dispensing apparatus according to a preferred embodiment of the invention;

FIG. 2 is a rear view of a part of the dispensing apparatus of FIG. 1;

FIG. 3 is a schematic diagram showing another dispensing apparatus; and

FIG. 4 is a schematic diagram showing a robot arm, which sucks a workpiece.

### DETAILED DESCRIPTION

The present invention will be apparent from the following detailed description, which proceeds with reference to the accompanying drawings, wherein the same references relate to the same elements.

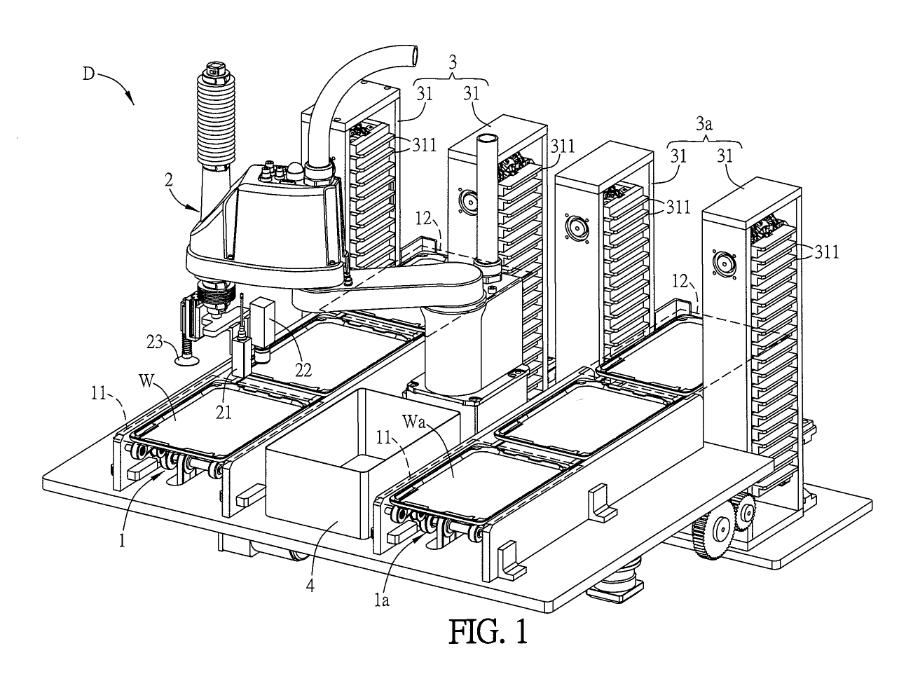

FIG. 1 is a schematic diagram showing a dispensing apparatus D according to a preferred embodiment of the invention. Referring to FIG. 1, the dispensing apparatus D is used to dispense glue on a workpiece W, so that a followed attaching process of the workpiece W can be performed. The workpiece W can be, for example but not limited to, a display panel, a touch panel or a casing of an electronic device such as a mobile phone, a tablet computer or a notebook computer. In this embodiment, the workpiece W is a casing of a tablet computer. The dispensing apparatus D includes a first conveyer 1, a robot arm 2 and a first storing module 3.

The first conveyer 1 includes a work region 11 and a storage region 12. The workpiece W is loaded on the first conveyer 1 and transmitted from the work region 11 to the storage region 12. The robot arm 2 is movably disposed adjacent to the work region 11, and the first storing module 3 is disposed adjacent to the storage region 12. In the initial of the dispensing operation, the workpiece W is located in the work region 11. After the robot arm 2 dispenses glue on the workpiece W, the first conveyer 1 transmits the workpiece W from the work region 11 to the storage region 12. Then, the dispensed workpiece W is transmitted to the first storing module 3. To be noted, the glue dispensing positions of the workpiece W (e.g. the edge of the workpiece W) are determined based on the product requirement, and this invention is not limited.

The robot arm 2 can provide a horizontal displacement (X-axis and Y-axis) and a vertical displacement (Z-axis) by, for example but not limited to, a cylinder. The robot arm 2 includes a dispensing unit 21 and an image identifying unit 22. The image identifying unit 22 retrieves an image signal of the work region 11. The robot arm 2 can control the dispensing unit 21 to dispense glue on the workpiece W according to the image signal of the work region 11. In practice, the dispensing unit 21 can be a contact or non-contact dispensing tip. In this embodiment, the dispensing unit 21 is a non-contact dispensing tip. The image identifying unit 22 can be, for example but not limited to, a CCD (Charge-Coupled Device) sensor or a CMOS (Complementary Metal Oxide Semiconductor) sensor. In both of the CCD and CMOS sensors, the sensing areas are arranged in a pixel array on the semiconductor substrate for collecting light and then transforming the light into electrodes. Herein, the image identifying unit 22 retrieves the position of the workpiece W on the first conveyer 1 and transforms it to an image signal, so that the robot arm 2 can obtain a precise coordinates information. Accordingly, the dispensing unit 21 can precisely dispense glue on the desired positions on the workpiece W.

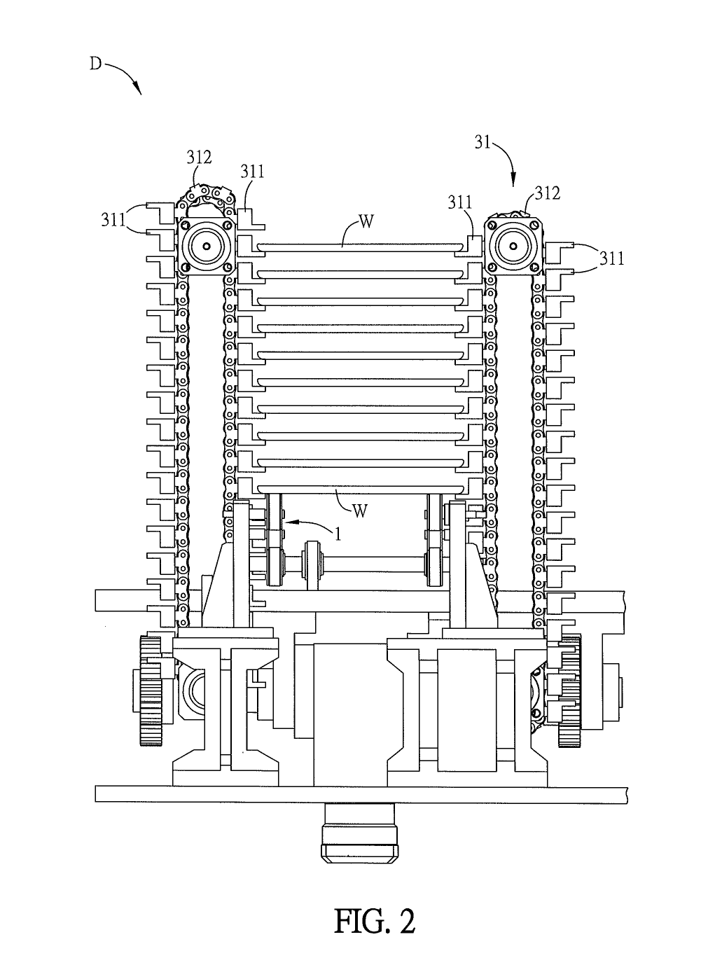

The first storing module 3 supports the dispensed workpiece W and lifts it away from the first conveyer 1. FIG. 2 is a rear view of a part of the dispensing apparatus D of FIG. 1, wherein FIG. 2 does not show the casing of the storing module 3 for the purpose of clear illustration. Referring to FIGS. 1 and 2, the first storing module 3 includes two storing units 31 disposed opposite to each other. Each storing unit 31 has a plurality of supporting portions 311, which are linked and driven by a chain 312. The supporting portions 311 of each storing unit 31 are arranged two by two. After the dispensed workpiece W is transmitted to the storage region 12, the chain 312 of each storing unit 31 is enabled so as to lift the supporting portions 311. Accordingly, the corresponding supporting portions 311 can support the workpiece W and lift it. As a result, the dispensed workpiece W is suspended above the conveyer 1, and the next workpiece W can be moved to the storage region 12. Afterwards, the storing module 3 repeats the above operations to lift the next workpiece W. After repeating the above operations for several times, the storing unit 31 can store a plurality of dispensed workpieces W. The storing unit 31 as well as the stored workpieces W can be transported to the next process machine for performing the following process.

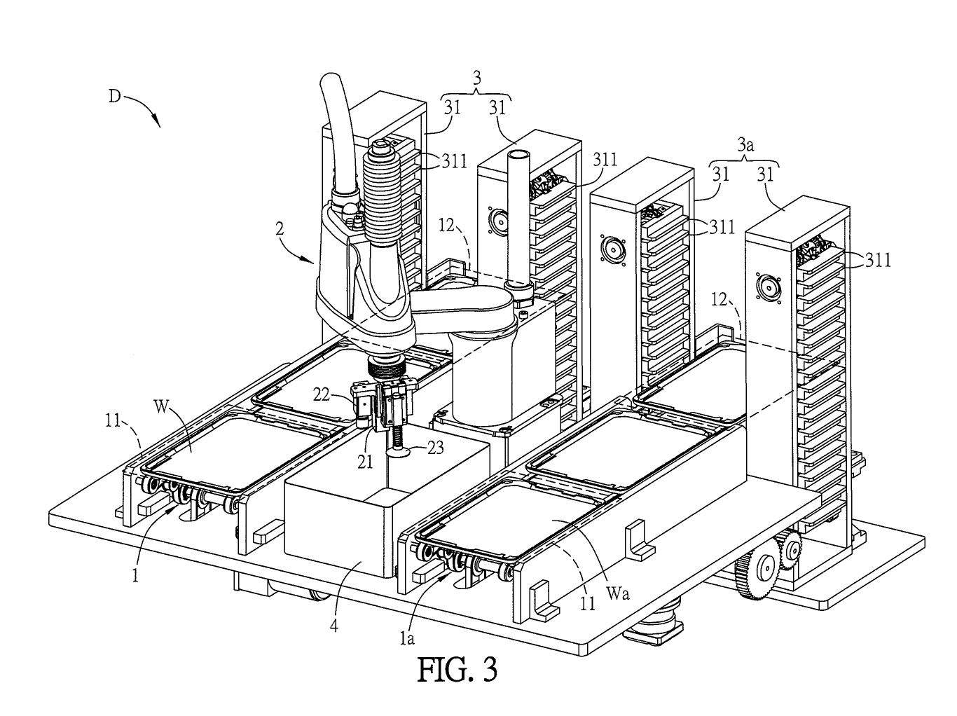

FIG. 3 is a schematic diagram showing another dispensing apparatus. As shown in FIG. 3, the dispensing apparatus D further includes an accommodating box 4 disposed adjacent to the work region 11. When the dispensing apparatus D is in a waiting mode or is shut down, the robot arm 2 will move the dispensing unit 21 to a position above the accommodating box 4. Accordingly, the glue dropped from the dispensing unit 21 can be caught by the accommodating box 4, so the conveyer 1 is not affected by the dropped glue.

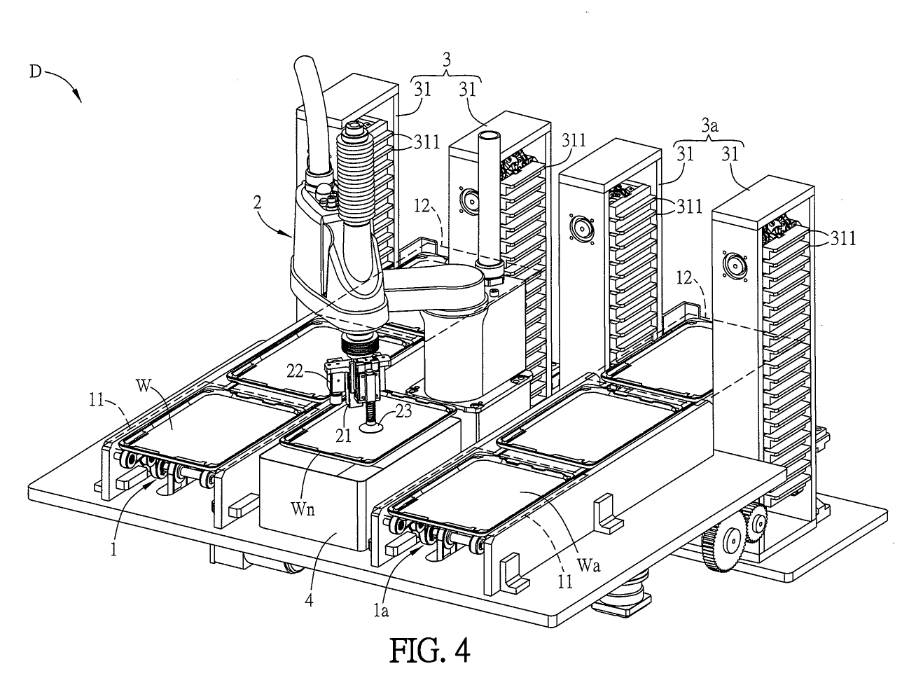

As mentioned above, the robot arm 2 further includes a suction unit 23. The image identifying unit 22 retrieves the image signal of the dispensed workpiece W so as to determine whether the glue is dispensed on the correct position on the workpiece W. FIG. 4 is a schematic diagram showing a robot arm 2, which sucks a workpiece. Referring to FIG. 4, when it determines that the workpiece Wn is not properly processed in the dispensing process, the robot arm 2 controls the suction unit 23 to suck the workpiece Wn according to the image signal of the workpiece Wn and places the workpiece Wn in the accommodating box 4. In practice, the image identifying unit 22 can retrieve the IR images of the workpiece W before and after the dispensing process or the light reflection or refraction variation of the position of the dispensed glue, which can be used to determine whether the dispensing process of the workpiece W is properly performed or not. In this embodiment, the dispensing apparatus D can detect out the failed workpiece Wn by the image identifying unit 22 and the suction unit 23, thereby improving the quality of the products.

In this embodiment, the dispensing apparatus D further includes a second conveyer 1a and a second storing module 3a. The second conveyer 1a is disposed at one side of the robot arm 2, while the first conveyer 1 and the second conveyer 1a are located at opposite sides of the robot arm 2. Another workpiece Wa is loaded on the second conveyer 1a. The second storing module 3a is disposed at one side of the robot arm 2, while the first storing module 3 and the second storing module 3a are located at opposite sides of the robot arm 2. In brief, the dispensing apparatus D includes a robot arm 2, two conveyers 1 and 1a, and two storing modules 3 and 3a. The conveyers and storing modules are symmetrically disposed at two sides of the robot arm 2. In practice, after the robot arm 2 dispenses glue on the workpiece W loaded on the first conveyer 1, the first conveyer 1 delivers the workpiece W to the storage region 12. At the same time, the robot arm 2 moves to the second conveyer 1a and dispenses glue on the workpiece Wa loaded on the second conveyer 1a. Similarly, when the second conveyer 1a delivers the workpiece Wa to the storage region 12, the first conveyer a is loaded with another workpiece W, and the robot arm 2 moves back to the first conveyer 1 and dispenses glue on the next workpiece W. Accordingly, this embodiment utilizes two conveyers sharing a single robot arm 2, so that the robot arm 2 can perform the dispensing process on the workpiece loaded on one conveyer (e.g. the workpiece Wa loaded on the second conveyer 1a) while the other conveyer delivers the other workpiece (e.g. the first conveyer 1 delivers the workpiece W). This configuration can maximally operate the robot arm so as to improve the production performance. In addition, a horizontal projection area of the modulated dispensing apparatus D is 1 m² only, which is more compact than the conventional dispensing apparatus, so it is possible to increase the utilization ratio of the factory space.

In summary, the dispensing apparatus of the invention is configured with an image identifying unit disposed on the robot arm, so it can precisely dispense glue on the workpiece so as to reduce the tolerance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dispensing apparatus used to dispense glue on a workpiece, the dispensing apparatus comprising:
a first conveyer having a work region and a storage region, wherein the workpiece is loaded on the first conveyer and transmitted from the work region to the storage region;
a robot arm being movably disposed adjacent to the work region, wherein the robot arm has a dispensing unit and an image identifying unit, the image identifying unit retrieves an image signal of the work region, the robot arm controls the dispensing unit to dispense glue on the workpiece according to the image signal of the work region, and the first conveyer transmits the dispensed workpiece from the work region to the storage region; and
a first storing module disposed adjacent to the storage region, wherein the first storing module supports the dispensed workpiece and lifts it away from the first conveyer.

2. The dispensing apparatus of claim 1, wherein the first storing module comprises two storing units disposed facing to each other, each of the storing units has a plurality of supporting portions for supporting and lifting the dispensed workpiece.

3. The dispensing apparatus of claim 1, further comprising an accommodating box disposed adjacent to the work region.

4. The dispensing apparatus of claim 3, wherein the robot arm further has a suction unit, the image identifying unit retrieves the image signal of the dispensed workpiece, the robot arm controls the suction unit to suck the dispensed workpiece according to the image signal of the dispensed workpiece and places the dispensed workpiece in the accommodating box.

5. The dispensing apparatus of claim 1, wherein the image identifying unit is a CCD sensor or a CMOS sensor.

6. The dispensing apparatus of claim 1, wherein the workpiece comprises a display panel, a touch panel or a casing of an electronic device.

7. The dispensing apparatus of claim 1, further comprising:
a second conveyer disposed at one side of the robot arm, wherein the first conveyer and the second conveyer are located at opposite sides of the robot arm, and another workpiece is loaded on the second conveyer; and
a second storing module disposed at one side of the robot arm, wherein the first storing module and the second storing module are located at opposite sides of the robot arm.

8. The dispensing apparatus of claim 1, wherein a horizontal projection area of the dispensing apparatus is 1 m².
